(19) United States
(12) Patent Application Publication
(10) Pub. No.: US 2013/0122377 A1
(43) Pub. Date: May 16, 2013

(54) ELECTROLYTE SOLUTION FOR A LITHIUM SECONDARY BATTERY AND LITHIUM SECONDARY BATTERY COMPRISING THE SAME

(71) Applicants: Soo Young KIM, Seongnam-si (KR); Ji Seong HAN, Suwon-si (KR); Eun Gi SHIM, Yongin-si (KR); Ji Young CHOI, Daegu-si (KR); Wan Chul KANG, Jincheon-gun (KR)

(72) Inventors: Soo Young KIM, Seongnam-si (KR); Ji Seong HAN, Suwon-si (KR); Eun Gi SHIM, Yongin-si (KR); Ji Young CHOI, Daegu-si (KR); Wan Chul KANG, Jincheon-gun (KR)

(73) Assignee: SOULBRAIN CO., LTD., Seongnam-si (KR)

(21) Appl. No.: 13/591,912

(22) Filed: Aug. 22, 2012

(30) Foreign Application Priority Data
Nov. 15, 2011 (KR) 10-2011-0118985

(51) Int. Cl. H01M 10/056; H01M 10/0569; H01M 10/0564

(52) U.S. Cl. 429/331; 429/188; 429/341; 429/324; 429/342; 429/326; 429/338; 429/332; 429/199

(57) ABSTRACT

Provided are an electrolyte solution for lithium secondary battery, which includes dipentaerythritol hexaacrylate and a (meth)acrylate compound having a C₄ to C₁₂ linear or branched alkyl group as electrolyte additives, and a lithium secondary battery including the electrolyte solution. The electrolyte solution can improve the safety of the battery, and the performance characteristics, particularly cycle life characteristics, of the battery.

### BACKGROUND OF THE INVENTION

1. Field of the Invention

The present invention relates to an electrolyte solution for a lithium secondary battery, which can improve the safety and cycle life characteristics of a lithium secondary battery, and a lithium secondary battery including the electrolyte solution.

2. Description of Related Art

Recently, along with the rapid development of electric equipment such as mobile telephones and laptop computers, lithium secondary batteries which have higher energy densities and superior cycle life characteristics as compared with conventional nickel-hydrogen (Ni-MH) batteries and nickel-cadmium (Ni-Cd) batteries, are being used with increasing popularity. As a result of such an increase in the use of lithium secondary batteries, there is a strong demand for improvements in the safety, cycle life characteristics, and capacity of lithium secondary batteries, in order to secure the safety for application equipment and users.

The average discharge voltage of lithium secondary batteries is about 3.6 to 3.7 V, and higher electric power can be obtained therefrom as compared with other alkali batteries, Ni-MH batteries, Ni-Cd batteries and the like. However, in order to give such a high driving voltage, an electrolyte solution having an electrochemically stable composition in the charge-discharge voltage range of 0 V to 4.6 V is needed.

As the electrolyte solution for lithium secondary batteries, non-aqueous electrolyte solutions obtained by dissolving lithium salts in carbonate-based aprotic solvents are generally used. However, a lithium secondary battery using a non-aqueous electrolyte solution is such that if the battery temperature rises, volatilization of the aprotic solvent is prone to occur inside the battery, and as a result, there occur problems such as expansion of the battery, and diffusion of the volatilized gas or liquid leakage due to leaks. Furthermore, there is also a problem that when the battery casing is damaged, it is difficult to secure safety due to liquid leakage.

In order to solve these problems, a battery system utilizing a polymer electrolyte has been developed. The polymer electrolyte is an ion conductor which is a uniform solid solution of an alkali metal salt in a polymer. Since the polymer electrolyte does not use a solvent, there is no risk of the diffusion of volatilized gas or liquid leakage, and since the current flows uniformly throughout the electrolyte, it is possible to suppress the generation and growth of lithium dendrites. However, such a polymer electrolyte has a problem that the ion conductivity is low compared with the non-aqueous electrolytes. Therefore, a battery using a polymer electrolyte has a large internal resistance value, and the current output that can be discharged per unit time is markedly low as compared with those secondary batteries using non-aqueous electrolytes. Accordingly, there is a problem that the application range of batteries using polymer electrolytes is quite limited.

As a measure for solving the problem of low ion conductivity of polymer electrolytes, there has been suggested a gel-like polymer electrolyte in which a polymer is impregnated with a non-aqueous electrolyte solution. Specifically, Japanese Patent

Application Laid-Open No. 1996-507407 discloses a gel-like electrolyte produced by swelling polyvinylidene fluoride with a non-aqueous electrolyte. However, since polyvinylidene fluoride is less capable of retaining non-aqueous electrolyte solutions, and thus, there is a risk that diffusion of volatile gases or liquid leakage may occur, which is a problem posed by non-aqueous electrolyte solutions.

U.S. Pat. No. 5,603,982 also discloses a gel-like electrolyte which uses a three-dimensionally crosslinked acrylic polymer produced by crosslinking an acrylic monomer with a crosslinking agent. However, because acrylic monomers themselves do not exhibit sufficient polymerizability, there is a problem that a large amount of unreacted double bonds remain, and the cycle characteristics are deteriorated.

### SUMMARY OF THE INVENTION

An object of the present invention is to provide an electrolyte solution for a lithium secondary battery, which can improve the safety and cycle life characteristics of lithium secondary battery.

Another object of the present invention is to provide a lithium secondary battery including the electrolyte solution described above.

In order to achieve the objects described above, an electrolyte s olution for lithium secondary battery according to an aspect of the present invention includes, as electrolyte additives, dipentaerythritol hexaacrylate and a (meth)acrylate compound having a C₄ to C₁₂ linear or branched alkyl group.

The (meth)acrylate compound may be any one selected from the group consisting of butyl methacrylate, butyl acrylate, isobutyl methacrylate, isobutyl acrylate, pentyl acrylate, pentyl methacrylate, isopentyl methacrylate, isopentyl acrylate, hexyl acrylate, hexyl methacrylate, isohexyl methacrylate, isohexyl acrylate, heptyl acrylate, heptyl methacrylate, isoheptyl methacrylate, isoheptyl acrylate, octyl acrylate, octyl methacrylate, isooctyl acrylate, isooctyl methacrylate, and a mixture thereof.

The electrolyte additives may be incorporated in an amount of 0.1% to 10% by weight to the total weight of the electrolyte solution.

The dipentaerythritol hexaacrylate and the (meth)acrylate compound may be incorporated at a weight ratio of 6:1 to 1:1.

The electrolyte solution may further include an organic solvent selected from the group consisting of ester solvents, ether solvents, ketone solvents, aromatic hydrocarbon solvents, carbonate solvents, and a mixture thereof.

The electrolyte solution may further include an organic solvent which includes an organic solvent having a high dielectric constant and an organic solvent having low viscosity at a volume ratio of 3:7 to 7:3.

The organic solvent having a high dielectric constant may be any one selected from the group consisting of ethylene carbonate, propylene carbonate, and a mixture thereof The organic solvent having low viscosity may be any one selected from the group consisting of ethyl methyl carbonate, dimethyl carbonate, diethyl carbonate, and a mixture thereof.

The electrolyte solution may further include a lithium salt selected from the group consisting of LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiN(CₐF₂ₐ₊₁SO₂)(C_{b}F_{2b+1}SO₂) (provided that a and b represent natural numbers), LiCl, LiI, and a mixture thereof.

The electrolyte solution may further include a polymerization initiator selected from the group consisting of organic peroxides, azo compounds, and a mixture thereof The electrolyte solution may include the polymerization initiator in an amount of 0.01% to 1% by weight to the total weight of the electrolyte composition.

The electrolyte solution may further include an additive selected from the group consisting of vinylene carbonate, a metal fluoride, glutaronitrile, succinonitrile, adiponitrile, 3,3′-thiodipropionitrile, 1,3-propanesultone, 1,3-propenesultone, lithium bis(oxalato)borate), vinylethylene carbonate, and a mixture thereof.

A lithium secondary battery according to another aspect of the present invention includes a cathode containing a cathode active material, an anode containing an anode active material, and an electrolyte solution interposed between the cathode and the anode, and the electrolyte solution includes, as electrolyte additives, dipentaerythritol hexaacrylate, and a (meth)acrylate compound having a C₄ to C₁₂ linear or branched alkyl group.

Other specific terms for the embodiments of the present invention will be described in the detailed description of the invention.

The electrolyte solution for lithium secondary batteries according to the present invention can improve the battery safety at normal temperature and high temperatures, as well as the performance characteristics, particularly cycle life characteristics, as dipentaerythritol hexaacrylate and the (meth)acrylate compound included in the electrolyte solution undergo physical gelation.

### BRIEF DESCRIPTION OF THE DRAWINGS

The embodiments will become more apparent to those of ordinary skill in the art by describing in detail exemplary embodiments with reference to the attached drawings, in which:

FIG. 1 illustrates an explosion perspective view of a lithium secondary battery according to an embodiment of the present invention.

FIG. 2 illustrates a graph showing the evaluation results for the cycle life characteristics of the lithium secondary batteries produced in Example 5 and Comparative Examples 1 to 7.

### REFERENCE NUMERALS

1: Lithium secondary battery

3: Anode

5: Cathode

7: Separator

9: Electrode assembly

10, 13: Lead members

15: Casing

### DETAILED DESCRIPTION OF THE INVENTION

Hereinafter, embodiments of the present invention will be described in detail. However, these embodiments are only for illustrative purposes, and the present invention is not intended to be limited thereby. The present invention is to be defined only by the scope of the claims that will be described below.

The term “alkyl” as used herein means a linear or branched, saturated hydrocarbon radical chain having 4 to 12 carbon atoms, and examples thereof may include, but are not limited to, n-butyl, isobutyl, t-butyl, n-pentyl, isopentyl, n-hexyl, isohexyl, n-heptyl, isoheptyl, n-octyl, isooctyl, nonyl, isononyl, decyl, isodecyl, undecyl, isoundecyl, dodecyl, and isododecyl.

The term “(meth)acrylate” as used herein may include acrylate compounds and methacrylate compounds.

According to the present invention, when a liquid electrolyte formed as a result of physical gelation of dipentaerythritol hexaacrylate and a (meth)acrylate compound is used, the battery safety at normal temperature and at high temperature can be secured, and also, performance characteristics of the battery, particularly cycle life characteristics, can be enhanced.

That is, an electrolyte solution for a lithium secondary battery according to an embodiment of the present invention includes an organic solvent, as well as a lithium salt, electrolyte additives, and a polymerization initiator mixed in the organic solvent. The electrolyte additives may include dipentaerythritol hexaacrylate and a (meth)acrylate compound containing a linear or branched alkyl group having 4 to 12 carbon atoms.

The dipentaerythritol hexaacrylate contains six acrylic groups, and this compound is capable of gelation with a (meth)acrylate compound even in a small amount, as compared with dipentaerythritol tetraacrylate containing four acrylic groups and trimethylolpropane triacrylate containing three acrylic groups.

As the (meth)acrylate compound, an acrylate compound or a methacrylate compound, each containing a linear or branched alkyl group having 4 to 12 carbon atoms, can be used.

Specific examples thereof may include butyl methacrylate, butyl acrylate, isobutyl methacrylate, isobutyl acrylate, pentyl acrylate, pentyl methacrylate, isopentyl methacrylate, isopentyl acrylate, hexyl acrylate, hexyl methacrylate, isohexyl methacrylate, isohexyl acrylate, heptyl acrylate, heptyl methacrylate, isoheptyl methacrylate, isoheptyl acrylate, octyl acrylate, octyl methacrylate, isooctyl acrylate, isooctyl methacrylate, nonyl methacrylate, nonyl acrylate, isononyl methacrylate, isononyl acrylate, decyl methacrylate, decyl acrylate, isodecyl methacrylate, isodecyl acrylate, undecyl methacrylate, undecyl acrylate, isoundecyl acrylate, isoundecyl methacrylate, dodecyl methacrylate, dodecyl acrylate, isododecyl methacrylate, and isododecyl acrylate. . These can be used singly, or two or more kinds can be used in mixture. Preferred examples may include butyl methacrylate, butyl acrylate, isobutyl methacrylate, isobutyl acrylate, pentyl acrylate, pentyl methacrylate, isopentyl methacrylate, isopentyl acrylate, hexyl acrylate, hexyl methacrylate, isohexyl methacrylate, isohexyl acrylate, heptyl acrylate, heptyl methacrylate, isoheptyl methacrylate, isoheptyl acrylate, octyl acrylate, octyl methacrylate, isooctyl acrylate, isooctyl methacrylate, and a mixture thereof More preferably, it may be desirable to use butyl methacrylate which has excellent strength and an excellent adhesiveness increasing effect.

The dipentaerythritol hexaacrylate and (meth)acrylate compound undergo physical gelation by a polymerization initiator. Therefore, a lithium secondary battery including these compounds as electrolyte additives can exhibit excellent safety without any risk for liquid leakage even upon damage of the battery casing. Furthermore, since the mechanism by which the solvent is decomposed is suppressed so that side reactions are minimized, and gas generation is suppressed, the lithium secondary battery can exhibit improved performance characteristics, particularly cycle life characteristics.

The electrolyte additives including dipentaerythritol hexaacrylate and a (meth)acrylate compound, may be preferably included in an amount of 0.1% to 10% by weight to the total weight of the electrolyte solution. If the content of the electrolyte additives is less than 0.1% by weight, sufficient polymers may be not formed, and as a result, the intended effect may not be obtained. There may be also a risk that the resulting polymers may not play the role as a gel polymer, which is not preferable. If the content is greater than 10% by weight, the additives may drastically decrease the ion conductivity of the electrolyte solution, and the volume may increase excessively during the process of polymerization, which may be not preferable. The content of the electrolyte additives may be more preferably 0.5% to 5% by weight, and even more preferably 1% to 5% by weight, from the viewpoints of electrochemical characteristics and physical characteristics.

Furthermore, it is preferable that the dipentaerythritol hexaacrylate and the (meth)acrylate compound be included at a weight ratio of 6:1 to 1:1, within the content range of the electrolyte additives described above. If the content of the (meth)acrylate compound with respect to dipentaerythritol hexaacrylate is excessively high and out of the range of the weight ratio mentioned above, there may be a risk that the hardness of the resulting gel polymer may be too low, which may be not preferable. Also, if the content of dipentaerythritol hexaacrylate with respect to the (meth)acrylate compound is excessively high, there may be a risk that the adhesive strength may be decreased, and the volume may expand, which may be not preferable. It is more preferable that the dipentaerythritol hexaacrylate and the (meth)acrylate compound may be included at a weight ratio of 3:1 to 2:1.

There are no particular limitations on the organic solvent, as long as the organic solvent can play the role as a medium through which ions participating in the electrochemical reaction of the battery can migrate. Specific examples of the organic solvent may include ester solvents, ether solvents, ketone solvents, aromatic hydrocarbon solvents, and carbonate solvents, and these can be used singly, or as mixtures of two or more kinds.

Specific examples of the ester solvents may include methyl acetate, ethyl acetate, n-propyl acetate, dimethyl acetate, methyl propionate, ethyl propionate, γ-butyrolactone, decanolide, γ-valerolactone, mevalonolactone, γ-caprolactone, δ-valerolactone, and ε-caprolactone. Specific examples of the ether solvents may include dibutyl ether, tetraglyme, 2-methyltetrahydrofuran, and tetrahydrofuran. Specific examples of the ketone solvents include cyclohexanone. Specific examples of the aromatic hydrocarbon organic solvents may include benzene, fluorobenzene, chlorobenzene, iodobenzene, tolene, fluorotoluene, and xylene. Specific examples of the carbonate solvents may include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethyl methyl carbonate (EMC), ethylene carbonate (EC), propylene carbonate (PC), butylene carbonate (BC), and fluoroethylene carbonate (FEC).

As the organic solvent, it may be preferable to use a carbonate solvent, and among the carbonate solvents, it may be more preferable to use a mixture of a carbonate organic solvent having a high dielectric constant, which has high ion conductivity and is capable of increasing the charge-discharge performance of a battery, and a carbonate organic solvent having low viscosity, which can appropriately adjust the viscosity of the organic solvent having a high dielectric constant.

Specifically, an organic solvent having a high dielectric constant selected from the group consisting of ethylene carbonate, propylene carbonate and a mixture thereof, and an organic solvent having low viscosity selected from the group consisting of ethyl methyl carbonate, dimethyl carbonate, diethyl carbonate, and a mixture thereof, can be used in mixture. More preferably, it may be desirable to use a mixture of an organic solvent having a high dielectric constant and an organic solvent having low viscosity as described above, at a volume ratio of 3:7 to 7:3, and most preferably, it may be desirable to use a 3:5:2 solvent mixture of ethylene carbonate/ethyl methyl carbonate/diethyl carbonate.

The lithium salt is not particularly limited as long as it is a compound capable of providing lithium ions that are used in a lithium secondary battery. Specific examples of the lithium salt that can be used include LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂. LiN(CₐF₂ₐ₊₁SO₂)(C_{b}F_{2b+1}SO₂) (wherein a and b are each a natural number, and preferably 1≦a≦20, while 1≦b≦20), LiCl, LiI and a mixture thereof. Preferably, lithium hexafluorophosphate (LiPF₆) may be used.

When the lithium salt is incorporated into an electrolyte solution, the lithium salt may be dissolved in the electrolyte solution, and act as a source for lithium ion in the battery, and the transfer of lithium ions between a cathode and an anode can be promoted.

Such a lithium salt may be included in the electrolyte solution in an amount of 0.6 to 2 moles/liter, and preferably 0.7 to 1.6 moles/liter. If the concentration of the lithium salt is less than 0.6 moles/liter, the electrical conductivity of the electrolyte may decrease, and the electrolyte performance may deteriorate. If the concentration is greater than 2 moles/liter, the viscosity of the electrolyte may increase, and the mobility of lithium ions may be decreased.

Examples of the polymerization initiator may include organic peroxides and azo compounds, and these can be used singly or as mixtures of two or more kinds.

Specific examples of the organic peroxides may include peroxydicarbonates such as di-(4-t-butylcyclohexyl) peroxydicarbonate, di-2-ethylhexyl peroxydicarbonate, diisopropyl peroxydicarbonate, di-3-methoxybutyl peroxydicarbonate, t-butyl peroxyisopropyl carbonate, t-butyl peroxy-2-ethylhexyl carbonate, 1,6-bis(t-butyl peroxycarbonyloxy)hexane, and diethylene glycol bis(t-butyl peroxycarbonate); diacyl peroxides such as diacetyl peroxide, dibenzoyl peroxide, dilauroyl peroxide, and bis-3,5,5-trimethylhexanoyl peroxide; and peroxy esters such as t-butyl peroxypivalate, t-amyl peroxypivalate, t-butyl peroxy-2-ethylhexanoate, t-hexyl peroxypivalate, t-butyl peroxyneodecanoate, t-butyl peroxyneoheptanoate, t-hexyl peroxypivalate, 1,1,3,3-tetramethylbutyl peroxyneodecanoate, 1,1,3,3-tetramethylbutyl 2-ethylhexanoate, t-amyl peroxy-2-ethylhexanoate, t-butyl peroxyisobutyrate, t-amyl peroxy-3,5,5-trimethylhexanoate, t-butyl peroxy-3,5,5 -trimethylhexanoate, t-butyl peroxyacetate, t-butyl peroxybenzoate, and dibutyl peroxytrimethyl adipate. These can be used singly or as mixtures of two or more kinds. Specific examples of the azo compounds may include 2,2′-azobis(isobutyronitrile), 2,2′-azobis(2,4-dimethylvaleronitrile), and 1,1′-azobis(cyanocyclohexane). These can be used singly or as mixtures of two or more kinds.

It may be preferable that the polymerization initiator such as described above be included in an amount of 0.01% to 1% by weight to the total weight of the electrolyte solution. If the content of the polymerization initiator is less than 0.01% by weight, the gelation ratio may be not sufficient, and if the content is greater than 1% by weight, the polymer reaction due to the initiator may proceed excessively, so that gas generation may be accelerated, and the electrochemical characteristics of the battery may be deteriorated, which is not preferable.

The electrolyte solution according to the present invention may further include, in addition to the constituent components described above, additives that can be generally used in electrolyte solutions (hereinafter, referred to as “other additives”) for the purpose of enhancing the cycle life characteristics of the battery, suppressing a decrease in the battery capacity, enhancing the discharge capacity of the battery, and the like.

Specific examples of the other additives may include vinylene carbonate (VC), metal fluorides (for example, LiF, RbF, TiF, AgF, AgF₂, BaF₂, CaF₂, CdF₂, FcF₂, HgF₂, Hg₂F₂, MnF₂, NiF₂, PbF₂, SnF₂, SrF₂, XeF₂, ZnF₂, AlF₃, BF₃, BiF₃, CeF₃, CrF₃, DyF₃, EuF₃, GaF₃, GdF₃, FeF₃, HoF₃, InF₃, LaF₃, LuF₃, MnF₃, NdF₃, PrF₃, SbF₃, ScF₃, SmF₃, TbF₃, TiF₃, TmF₃, YF₃, YbF₃, TIF₃, CeF₄, GeF₄, HfF₄, SiF₄, SnF₄, TiF₄, VF₄, ZrF4₄, NbF₅, SbF₅, TaF₅, BiF₅, MoF₆, ReF₆, SF₆, WF₆, CoF₂, CoF₃, CrF₂, CsF, ErF₃, PF₃, PbF₃, PbF₄, ThF₄, TaF₅, and SeF₆), glutaronitrile (GN), succinonitrile (SN), adiponitrile (AN), 3,3′-thiodipropionitrile (TPN), 1,3-propanesultone (PS), 1,3-propene sultone (PRS), lithium bis(oxalato)borate (LIBOB), and vinylethylene carboante (VEC). These can be incorporated singly or as mixtures of two or more kinds.

The other additives may be incorporated in an amount of 0.1% to 1% by weight to the total weight of the electrolyte.

The electrolyte solution according to the present invention having a composition such as described above has excellent stability in the temperature range of −20° C. to 60° C., and can be electrochemically stable even at a voltage in the range of about 4 V. Thus, when the electrolyte solution is applied to a lithium secondary battery, the service life of the battery can be extended.

A lithium secondary battery may be classified as, e.g., a lithium ion battery, a lithium ion polymer battery, and/or a lithium polymer battery depending on kinds of a separator and an electrolyte; into a a cylindrical, prismatic, coin-type, pouch , and the like depending on a shape thereof; and into a bulk type, thin film type, and the like depending on asize thereof. Among these, the electrolyte solution according to the present invention may be particularly excellent to be applied to a lithium ion battery, aluminum laminate battery and/or a lithium polymer battery.

Therefore, according to another embodiment of the present invention, a lithium secondary battery including the electrolyte solution described above is provided.

More specifically, the lithium secondary battery described above may include a cathode containing a cathode active material, an anode containing an anode active material, and the electrolyte solution impregnating or surrounding the cathode and the anode.

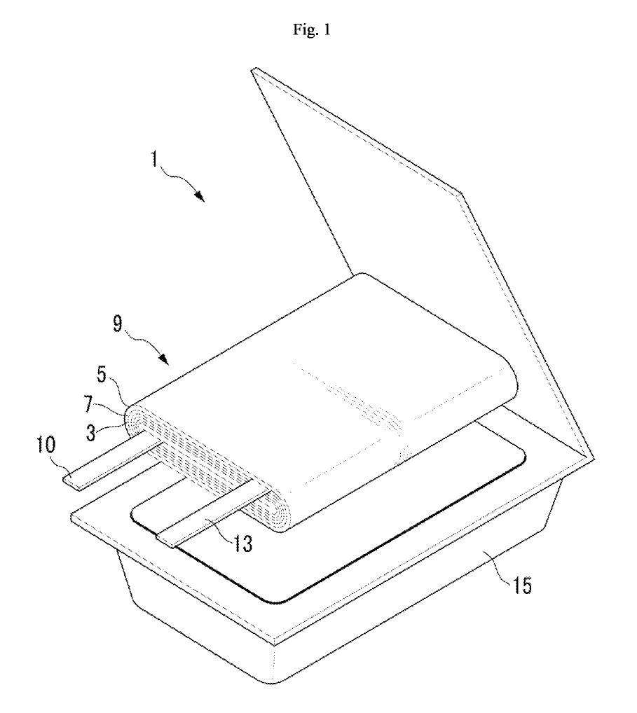

FIG. 1 illustrates an exploded perspective view of a lithium secondary battery (1) according to an embodiment of the present invention. FIG. 1 illustrates a pouch type lithium secondary battery, but the lithium secondary battery of the present invention is not intended to be limited to this shape, and any shape can be employed as long as the lithium secondary battery can operate as a battery.

According to FIG. 1, the lithium secondary battery (1) according to an embodiment of the present invention may be fabricated by sequentially laminating an anode (3), a cathode (5), and a separator (7) therebetween to produce an electrode assembly (9), housing this assembly in a casing (15), and injecting a non-aqueous electrolyte solution to thereby impregnate the anode (3), cathode (5) and separator (7) with the electrolyte solution. The electrolyte solution according to the present invention is such that when applied to a lithium secondary battery, gelation occurs between dipentaerythritol hexaacrylate and the (meth)acrylate compound. At this time, gelation occurs at normal temperature under the action of the polymerization initiator, but in order to further improve the cycle life characteristics of the battery by increasing the gelation ratio, a high temperature aging process can be optionally further carried out after the injection of the electrolyte solution into the electrode assembly during the production of the battery. Preferably, the high temperature aging process for the electrode assembly may be carried out at 70° C. to 100° C. for 2 to 5 hours.

The anode (3) and the cathode (5) may be respectively provided with conductive lead members (10, 13) for collecting the current generated at the time of battery operation, and the lead members (10, 13) may lead the current generated at the cathode (5) and the anode (3) to the cathode terminal and the anode terminal.

The cathode (5) can be produced by mixing a cathode active material, a conductive agent and a binder to prepare a composition for forming a cathode active material layer, subsequently applying the composition -on a cathode current collector such as an aluminum foil, and rolling the cathode current collector.

As the cathode active material may include a compound that can reversibly intercalate and deintercalate lithium (e.g., a lithiated intercalation compound).

Specifically, an olivine type lithium metal compound represented by the following formula (1) can be used:

[Chemical Formula 1]

LiₓM_{y}M′_{z}XO_{4-w}Y_{w}

wherein in the formula (1), M and M′ each independently may be an element selected from the group consisting of Fe, Ni, Co, Mn, Cr, Zr, Nb, Cu, V, Mo, Ti, Zn, Al, Ga, Mg, B and a combination thereof; X may be an element selected from the group consisting of P, As, Bi, Sb, Mo and a combination thereof; Y may be an element selected from the group consisting of F, S and a combination thereof; and 0<x≦1, 0<y≦1, 0<z≦1, 0<x+y+z≦2, and 0≦w≦0.5.

Among the compounds described above, it may be preferable to use a compound selected from the group consisting of LiCoO₂, LiMnO₂, LiMn₂O₄, LiNiₓMn_{(1-x)O}₂ (wherein, in the above Chemical Formula, 0<x<1), Li(M₁)ₓ(M₂)_{y}O₂ wherein, in the above Chemical Formula, 0≦x≦1, 0≦y≦1, 0≦x+y≦1, M₁ and M₂ each independently may be any one selected from the group consisting of Al, Sr, Mg and La), and a mixture thereof, from the viewpoint that the capacity characteristics and safety of the battery can be increased.

The anode (3) can be produced in the same manner as in the case of the cathode (5), by mixing an anode active material, a binder and optionally a conductive agent to prepare a composition for forming an anode active material layer, and then applying this composition on an anode current collector such as a copper foil.

As the anode active material may include a material that can reversibly intercalate/deintercalate lithium ions. Specific examples of the anode active material may include carbonaceous materials such as artificial graphite, natural graphite, graphitized carbon fiber, and amorphous carbon. Furthermore, in addition to the carbonaceous materials, a metal compound capable of alloying with lithium, or a composite containing a metal compound and a carbonaceous material can also be used as the anode active material.

Examples of a metal capable of alloying with lithium may include Si, Al, Sn, Pb, Zn, Bi, In, Mg, Ga, Cd, a Si alloy, a Sn alloy, and an Al alloy. Also, a lithium metal thin film can also be used as the anode active material.

As the anode active material, any one selected from the group consisting of crystalline carbon, non-crystalline carbon, a carbon composite, lithium metal, an alloy containing lithium, and a mixture thereof can be used, from the viewpoint of high safety. Since the terms for the electrolyte solution are the same as described above in connection with the electrolyte solution, the description will not be repeated here.

The lithium secondary battery can be produced by a conventional method, and a battery produced by using the electrolyte solution of the present invention can exhibit excellent safety at normal temperature and high temperatures, as well as improved performance characteristics, particularly cycle life characteristics.

Hereinafter, the present invention will be described in detail by way of Examples so that those having ordinary skill in the art can easily carry out the present invention. However, the present invention can be realized in various different forms, and is not intended to be limited to the Examples described herein.

Preparation Examples for electrolyte solution and lithium secondary batteries

In the following Examples, ethylene carbonate is abbreviated to EC, ethyl methyl carbonate to EMC, diethyl carbonate to DEC, dipentaerythritol hexaacrylate to DPHA, butyl methacrylate to BMA, hexyl methacrylate to HMA, hexyl acrylate to HA, dipentaerythritol tetraacrylate to DPTA, tetra(ethylene glycol) diacrylate to TEGDA, poly(ethylene glycol) diacrylate to PEGDA, trimethylolpropane triacrylate to PTA, vinylene carbonate to VC, and 2,2-azobis(2,4-dimethyl)valeronitrile to ABVN.

In the following Examples, a cathode produced by mixing LiCoO₂ as a cathode active material, carbon black as a conductive agent, polyvinylidene fluoride (PVDF) as a binder, and n-methyl-2-pyrrolidone (NMP) as a solvent to prepare a slurry, and coating the slurry on an aluminum (Al) substrate, was used. Also, an anode produced by mixing mesocarbon microbeads (MCMB) and carbon black as a anode active material, PVDF as a binder, and NMP as a solvent to prepare a slurry, and coating the slurry on a copper (Cu) substrate, was used.

The unit “percent (%)” used herein in connection with the content is on a weight basis.

### COMPARATIVE EXAMPLE 1

To a mixed solution of ethylene carbonate (EC), ethyl methyl carbonate (EMC), and diethyl carbonate (DEC) (EC/EMC/DEC=3/5/2 as a volume ratio), LiPF₆ was added to a concentration of 1.15 M, and thus an electrolyte solution was prepared. The electrolyte solution thus prepared, and the cathode and the anode produced in advance were used to produce a lithium secondary battery of aluminum pouch type (Al-pouch type) (hereinafter, referred to as E1).

### COMPARATIVE EXAMPLE 2

A lithium secondary battery (hereinafter, referred to as E2) was produced by the same method as that used in Comparative Example 1, except that DPTA was added in an amount of 3% by weight to the total weight of the electrolyte solution prepared in Comparative Example 1, during the preparation of the electrolyte solution.

### COMPARATIVE EXAMPLES 3 TO 7

Lithium secondary batteries (E3 to E7) were produced by the same method as that used in Comparative Example 1, except that the components and their contents as indicated in the following Table 1 were used.

TABLE 1

| | Organic solvent | | |
|---|---|---|---|
| | (volume ratio) | Lithium salt | Additives |
| Comparative Example 1 | EC/EMC/DEC = 3/5/2 | 1.15M LiPF₆ | — |
| (E1) | | | |
| Comparative Example 2 | EC/EMC/DEC = 3/5/2 | 1.15M LiPF₆ | DPTA (3 wt %) |
| (E2) | | | |
| Comparative Example 3 | EC/EMC/DEC = 3/5/2 | 1.15M LiPF₆ | DPTA (0.25 wt %) + TEGDA |
| (E3) | | | (0.25 wt %) |
| Comparative Example 4 | EC/EMC/DEC = 3/5/2 | 1.15M LiPF₆ | DPTA (3 wt %) + PEGDA |
| (E4) | | | (0.18 wt %) |
| Comparative Example 5 | EC/EMC/DEC = 3/5/2 | 1.15M LiPF₆ | PTA (1 wt %) |
| (E5) | | | |
| Comparative Example 6 | EC/EMC/DEC = 3/5/2 | 1.15M LiPF₆ | PTA (0.2 wt %) + TEGDA (0.8 |
| (E6) | | | wt %) |
| Comparative Example 7 | EC/EMC/DEC = 3/5/2 | 1.15M LiPF₆ | PTA (0.8 wt %) + TEGDA (0.2 |
| (E7) | | | wt %) |

### EXAMPLE 1

To a mixed solution of ethylene carbonate (EC), ethyl methyl carbonate (EMC) and diethyl carbonate (DEC) (EC/EMC/DEC=3/5/2 as a volume ratio), LiPF₆ was added to a concentration of 1.15 M, and then 3 wt % of dipentaerythritol hexaacrylate (DPHA) and 1 wt % of butyl methacrylate (BMA) as electrolyte additives, and 200 ppm of 2,2-azobis(2,4-dimethyl)valeronitrile (ABVN) as a polymerization initiator were added to the resulting mixed solution with respect to the total weight of the resulting mixed solution. Thus, an electrolyte solution was prepared. The electrolyte solution thus prepared, and the cathode and the anode produced in advance were used to produce a lithium secondary battery of aluminum pouch type (Al-pouch type) (hereinafter, referred to as E1A).

### EXAMPLES 2 TO 6

Lithium secondary batteries (E2A to E6A) were produced by the same method as that used in Example 1, except that the components and their contents as indicated in the following Table 2 were used.

TABLE 2

| | Organic solvent | | |
|---|---|---|---|
| | (volume ratio) | Lithium salt | Additives |
| Example 1 (E1A) | EC/EMC/DEC = | 1.15M LiPF₆ | DPHA (3 wt %) + BMA (1 wt %) |
| | 3/5/2 | | |
| Example 2 (E2A) | EC/EMC/DEC = | 1.15M LiPF₆ | DPHA (2 wt %) + BMA (1 wt %) |
| | 3/5/2 | | |
| Example 3 (E3A) | EC/EMC/DEC = | 1.15M LiPF₆ | DPHA (2 wt %) + HMA (1 wt %) |
| | 3/5/2 | | |
| Example 4 (E4A) | EC/EMC/DEC = | 1.15M LiPF₆ | DPHA (3 wt %) + HA (1 wt %) |
| | 3/5/2 | | |
| Example 5 (E5A) | EC/EMC/DEC = | 1.15M LiPF₆ | DPHA (1 wt %) + BMA (0.5 wt %) |
| | 3/5/2 | | |
| Example 6 (E6A) | EC/EMC/DEC = | 1.15M LiPF₆ | DPHA (1 wt %) + BMA (0.5 wt %) + |
| | 3/5/2 | | VC (0.1 wt %) |

### EXAMPLE 7

To a mixed solution of ethylene carbonate (EC), ethyl methyl carbonate (EMC) and diethyl carbonate (DEC) (EC/EMC/DEC=3/5/2 as a volume ratio), LiPF₆ was added to a concentration of 1.15 M, and then 1 wt % of dipentaerythritol hexaacrylate (DPHA) and 0.5 wt % of butyl methacrylate (BMA) as electrolyte additives, and 200 ppm of 2,2-azobis(2,4-dimethyl)valeronitrile (ABVN) as a polymerization initiator were added to the resulting mixed solution with respect to the total weight of the resulting mixed solution. Thus, an electrolyte solution was prepared. The electrolyte solution thus prepared, and the cathode and the anode produced in advance were used to produce a battery assembly, and then the battery assembly was subjecting to high temperature aging for 4 hours at 80° C. Thus, a lithium secondary battery of aluminum pouch type (Al-pouch type) (hereinafter, referred to as E7A) was produced.

Properties evaluation of lithium secondary batteries

1. Evaluation of cycle life characteristics

The batteries produced in Comparative Example 1 and Examples 1 to 4 (El and E1A to E4A) were respectively charged to 4.2 V (cut-off 1C) under the constant current (CC)/constant voltage (CV) conditions with a current of 910 mA, and then were respectively discharged again to 2.7 V with a current of 910 mA. This process was repeated 1300 times, and thus the cycle life characteristics were analyzed.

The cycle life performance evaluation was carried out at 45° C., and the results are presented in Table 3.

TABLE 3

| | 1 Cycle (mAh) | 1300 Cycles (mAh) | Efficiency (%) |
|---|---|---|---|
| Example 1 | 966.87 | 694.55 | 72.24 |
| Example 2 | 962.07 | 692.29 | 71.60 |
| Example 3 | 964.48 | 693.44 | 71.90 |
| Example 4 | 963.39 | 696.58 | 72.31 |
| Comparative | 963.13 | 635.57 | 65.99 |
| Example 1 | | | |

As shown in Table 3, the batteries of Examples 1 to 4, which include a mixture of dipentaerythritol hexaacrylate and a (meth)acrylate compound as electrolyte additives, exhibited markedly excellent cycle life characteristics as compared with the battery of Comparative Example 1, due to the physical gelation of the electrolyte additives.

2. Evaluation of cycle life characteristics

The batteries produced in Comparative Examples 1 to 7 and Example 5 (El to E7 and E5A) were respectively charged to 4.2 V (cut-off 1C) under the CC/CV conditions with a current of 2280 mA, and were respectively discharged to 2.7 V with a current of 2280 mA. This process was repeated 300 times, and thus the cycle life characteristics were measured.

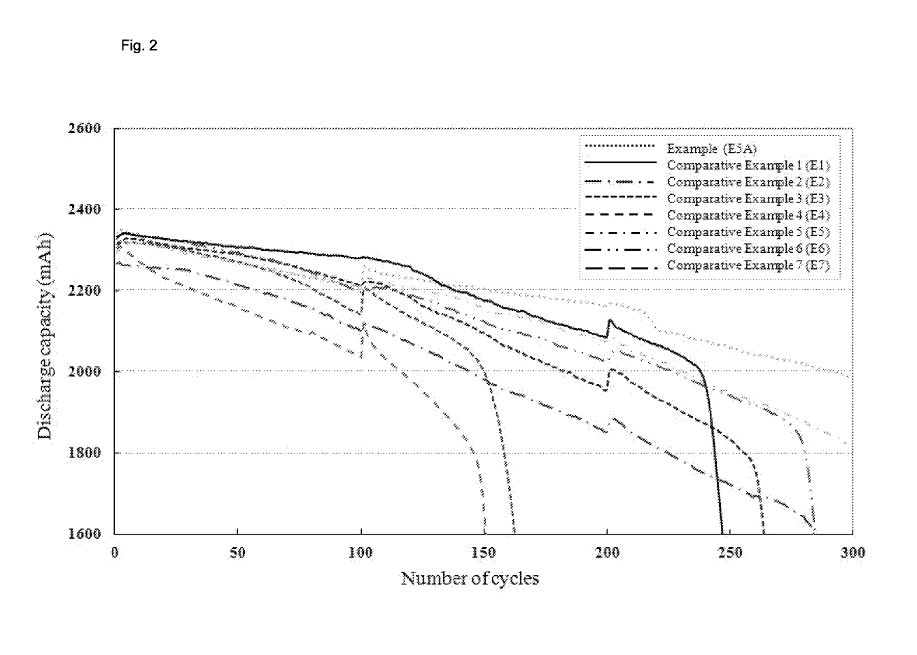

The cycle life performance evaluation was carried out at 45° C., and the results are presented in FIG. 2 and Table 4.

TABLE 4

| | 1 Cycle | 300 Cycles | Efficiency |
|---|---|---|---|
| | (mAh) | (mAh) | (%) |
| Example 5 | 2350.85 | 1987.01 | 84.52 |
| Comparative Example 1 | 2333.36 | Fail | N/A |
| Comparative Example 2 | 2270.11 | 1078.21 | 47.50 |
| Comparative Example 3 | 2316.28 | Fail | N/A |
| Comparative Example 4 | 2315.60 | Fail | N/A |
| Comparative Example 5 | 2293.43 | 1811.99 | 79.01 |
| Comparative Example 6 | 2337.38 | 557.51 | 23.85 |
| Comparative Example 7 | 2303.40 | Fail | N/A |

*Fail: The test was stopped due to the swelling of the battery.
*N/A: After 300 cycles, the discharge capacity was close to 0 mAh, and thus the efficiency was evaluated as 0%.

As shown in FIG. 2 and Table 4, the battery of Example 5, which included a mixture of dipentaerythritol hexaacryalte and a (meth)acrylate compound as electrolyte additives, exhibited markedly improved cycle life characteristics as compared with the batteries of Comparative Examples 2 to 7. This is because the gelation of dipentaerythritol hexaacrylate (DPHA) and the (meth)acrylate compound supported the non-aqueous electrolyte solution, and thereby the electrolyte stably exhibited high ion conductivity and minimized side reactions during the charge-discharge process. On the contrary, in the case of the batteries of Comparative Examples 3 and 4 which included a mixture of ditrimethylolpropane tetraacryalte (DPTA) and tetraethylene glycol diacrylate (TEGDA), and a mixture of ditrimethylolpropane tetraacrylate (DPTA) and poly(ethylene glycol) diacrylate (PEGDA), respectively, as electrolyte additives, polymers were formed, but physical gelation did not occur. Therefore, these batteries exhibited poor cycle life characteristics as compared with the battery of Example 5. Furthermore, in the case of the batteries of Comparative Examples 3 and 4, a serious battery swelling phenomenon occurred after 200 cycles, and it could be confirmed that the batteries did not have safety, which is an advantage of a gel polymer electrolyte. While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An electrolyte solution for lithium secondary battery, comprising dipentaerythritol hexaacrylate and a (meth)acrylate compound having a C₁ to C₄ linear or branched alkyl group, as electrolyte additives.

2. The electrolyte solution for lithium secondary battery according to claim 1, wherein the (meth)acrylate compound is any one selected from the group consisting of butyl methacrylate, butyl acrylate, isobutyl methacrylate, isobutyl acrylate, pentyl acrylate, pentyl methacrylate, isopentyl methacrylate, isopentyl acrylate, hexyl acrylate, hexyl methacrylate, isohexyl methacrylate, isohexyl acrylate, heptyl acrylate, heptyl methacrylate, isoheptyl methacrylate, isoheptyl acrylate, octyl acrylate, octyl methacrylate, isooctyl acrylate, isooctyl methacrylate, and a mixture thereof.

3. The electrolyte solution for lithium secondary battery according to claim 1, wherein the electrolyte additives are included in an amount of 0.1% to 10% by weight to the total weight of the electrolyte solution.

4. The electrolyte solution for lithium secondary battery according to claim 1, wherein the dipentaerythritol hexaacrylate and the (meth)acrylate compound are included at a weight ratio of 6:1 to 1:1.

5. The electrolyte solution for lithium secondary battery according to claim 1, further comprising an organic solvent selected from the group consisting of ester solvents, ether solvents, ketone solvents, aromatic hydrocarbon solvents, carbonate solvents, and a mixture thereof.

6. The electrolyte solution for lithium secondary battery according to claim 1, further comprising an organic solvent which includes an organic solvent having a high dielectric constant and an organic solvent having a low viscosity at a volume ratio of 3:7 to 7:3.

7. The electrolyte solution for lithium secondary battery according to claim 6, wherein the organic solvent having a high dielectric constant is any one selected from the group consisting of ethylene carbonate, propylene carbonate, and a mixture thereof, and the organic solvent having a low viscosity is any one selected from the group consisting of ethyl methyl carbonate, dimethyl carbonate, diethyl carbonate, and a mixture thereof

8. The electrolyte solution for lithium secondary battery according to claim 1, further comprising a lithium salt selected from the group consisting of LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiN(CₐF₂ₐ₊₁SO₂)(C_{b}F_{2b+1}SO₂) (provided that a and b each represent a natural number), LiCl, LiI, and a mixture thereof.

9. The electrolyte solution for lithium secondary battery according to claim 1, further comprising a polymerization initiator selected from the group consisting of organic peroxides, azo compounds, and a mixture thereof.

10. The electrolyte solution for lithium secondary battery according to claim 1, further comprising a polymerization initiator in an amount of 0.01% to 1% by weight to the total weight of the electrolyte solution.

11. The electrolyte solution for lithium secondary battery according to claim 1, further comprising an additive selected from the group consisting of vinylene carbonate, metal fluorides, glutaronitrile, succinonitrile, adiponitrile, 3,3′-thiodipropionitrile, 1,3-propane sultone, 1,3-propene sultone, lithium bis(oxalate)borate, vinylethylene carbonate, and a mixture thereof.

12. A lithium secondary battery comprising:
a cathode comprising a cathode active material and an anode comprising an anode active material, which are disposed to face each other; and
an electrolyte solution interposed between the cathode and the anode, wherein the electrolyte solution includes dipentaerythritol hexaacrylate and a (meth)acrylate compound having a C₄ to C₁₂ linear or branched alkyl group as electrolyte additives.
